(19) United States
(12) Patent Application Publication
(10) Pub. No.: US 2016/0189654 A1
(43) Pub. Date: Jun. 30, 2016

(54) GATE DRIVER FOR PROVIDING VARIABLE GATE-OFF VOLTAGE AND DISPLAY DEVICE INCLUDING THE SAME

(71) Applicant: Samsung Display Co., LTD., Yongin-City (KR)

(72) Inventors: Yoon Ho KIM, Asan-si (KR); Beom Jun KIM, Seoul (KR); Geun Hyuk CHOI, Suncheon-si (KR); Noboru TAKEUCHI, Asan-si (KR); Yong Soon LEE, Asan-si (KR); Jong Hwan LEE, Anyang-si (KR); Hong-Woo LEE, Seoul (KR); Yong-Sik HWANG, Yongin-si (KR)

(21) Appl. No.: 14/715,792

(22) Filed: May 19, 2015

(30) Foreign Application Priority Data
Dec. 24, 2014 (KR) 10-2014-0188948

(51) Int. Cl. G09G 3/36

(52) U.S. Cl. CPC G09G 3/3685; G09G 3/3607; G09G 2310/08; G09G 2320/0242; G09G 2320/041

(57) ABSTRACT

A display panel includes: a display panel including a plurality of gate lines, a plurality of data lines, and a plurality of pixels; a gate driver connected to the plurality of gate lines to apply a gate signal voltage; a data driver connected to the plurality of data lines to apply a data voltage and a negative data voltage; and a gate voltage divider for generating a gate signal voltage including gate-on and gate-off voltages to provided it to the gate driver. The gate voltage divider adjusts the gate-off voltage in accordance with a driving time of the display panel and a temperature of the display panel.

### CLAIM OF PRIORITY

This application claims the priority to and all the benefits accruing under 35 U.S.C. §119 from Korean Patent Application No. 10-2014-0188948 filed in the Korean Intellectual Property Office (KIPO) on Dec. 24, 2014, the entire contents of which are incorporated herein by reference.

### BACKGROUND OF THE INVENTION

1. Field of the Invention

This disclosure relates to a gate driver for providing a variable gate-off voltage and a display device including the same.

2. Description of the Related Art

Currently, liquid crystal displays (LCDs) or organic light emitting diode (OLED) displays are the most widely used flat panel displays.

Among them, the LCD consists of two sheets of substrates formed with electrodes and a liquid crystal layer interposed therebetween, and displays an image by controlling an amount of transmitted light by applying signals to the electrodes to realign liquid crystal molecules of the liquid crystal layer, while the OLED display is formed with organic light emitting diodes through which an appropriate current can flow to emit light in each pixel so as to display an image.

The LCD and the OLED display devices both include thin film transistors that are disposed to serve as switching elements in each pixel.

Amorphous silicon or polysilicon has been used as a semiconductor material for the thin film transistor, but recently, a thin film transistor using oxides as the semiconductor material has been developed and used.

The above information disclosed in this Background section is only for enhancement of understanding of the background of the invention and therefore it may contain information that does not form the prior art that is already known in this country to a person of ordinary skill in the art.

### SUMMARY OF THE INVENTION

An oxide semiconductor thin film transistor is superior in its characteristics to an amorphous silicon thin film transistor below a threshold voltage.

However, the oxide semiconductor is inferior in that a threshold voltage referenced at 1 nA is further negatively moved depending on temperature.

In addition, a driving stress of the thin film transistor causes the threshold voltage referenced at 1 nA to be negatively moved.

When the oxide semiconductor thin film transistor is directly used in the display device, a defect such as a washed-out color effect occurs not only due to an increased leakage current of the thin film transistor but also due to an increased driving time if it is driven at a high temperature.

The present invention has been made in an effort to solve this problem, thereby providing a display device that is capable of preventing a defect such as washed-out color effects due to an operation at a high temperature and due to an increased driving time.

A display device according to an exemplary embodiment of the present invention includes: a display panel including a plurality of gate lines, a plurality of data lines, and a plurality of pixels; a gate driver connected to the plurality of gate lines to apply a gate signal voltage; a data driver connected to the plurality of data lines to apply a data voltage and a negative data voltage; and a gate voltage divider for generating a gate signal voltage including gate-on and gate-off voltages to provide to the gate driver. The gate voltage divider adjusts the gate-off voltage in accordance with a driving time of the display panel and a temperature of the display panel.

The gate voltage divider may include: a driving time-reflecting unit for providing a voltage to be adjusted according to driving time of the display panel; a temperature-reflecting unit for providing a voltage to be adjusted according to the temperature of the display panel; and a voltage adjuster for outputting a voltage calculated by subtracting the voltages provided by the driving time-reflecting unit and the temperature-reflecting unit from a reference gate-off voltage.

The driving time-reflecting unit may include: a monitoring oscillator (OSC) for monitoring the driving time of the display panel; a programmable setting for outputting a preset voltage in response to the driving time provided by the monitoring OSC; and a driving time-reflecting voltage provider for providing an analog voltage corresponding to the voltage provided by the programmable setting to the voltage adjuster.

The temperature-reflecting unit may include a first resistor and a second resistor, and a variable resistor that is connected to the first resistor in series and to the second resistor in parallel.

The variable resistor may be a negative temperature coefficient (NTC) resistor.

The driving time-reflecting unit may determine the voltage to be adjusted by reflecting both performance deterioration of the thin film transistor according to elapse of the driving time of the display panel and performance restoration of the thin film transistor according to elapse of an operation stoppage time of the display panel.

The driving time-reflecting unit may include: a monitoring OSC for monitoring the driving time of the display panel and an operation stoppage time; a programmable setting for outputting a preset voltage in response to the driving time and the operation stoppage time provided by the monitoring OSC; and a driving time-reflecting voltage provider for providing an analog voltage corresponding to the voltage provided by the programmable setting to the voltage adjuster.

A gate driving device according to an exemplary embodiment of the present invention includes: a gate driver for outputting a gate signal voltage including gate-on and gate-off voltages for driving thin film transistors formed in a display panel; and a gate voltage divider for generating the gate signal voltage to provide it to the gate driver. The gate voltage divider adjusts the gate-off voltage in accordance with a driving time of the display panel and a temperature of the display panel.

The gate voltage divider may include: a driving time-reflecting unit for providing a voltage to be adjusted according to the driving time of the display panel; a temperature-reflecting unit for providing a voltage to be adjusted according to the temperature of the display panel; and a voltage adjuster for outputting a voltage calculated by subtracting the voltages provided by the driving time-reflecting unit and the temperature-reflecting unit from a reference gate-off voltage.

The driving time-reflecting unit may include: a monitoring OSC for monitoring the driving time of the display panel; a programmable setting for outputting a preset voltage in response to the driving time provided by the monitoring OSC; and a driving time-reflecting voltage provider for providing an analog voltage corresponding to the voltage provided by the programmable setting to the voltage adjuster.

The temperature-reflecting unit may include a first resistor and a second resistor, and a variable resistor that is connected to the first resistor in series and to the second resistor in parallel.

The variable resistor may be an NTC resistor.

The driving time-reflecting unit may determine the voltage to be adjusted by reflecting both performance deterioration of the thin film transistor according to elapse of the driving time of the display panel and performance restoration of the thin film transistor according to elapse of an operation stoppage time of the display panel.

The driving time-reflecting unit may include: a monitoring OSC for monitoring the driving time of the display panel and the operation stoppage time; a programmable setting for outputting a preset voltage in response to the driving time and the operation stoppage time provided by the monitoring OSC; and a driving time-reflecting voltage provider for providing an analog voltage corresponding to the voltage provided by the programmable setting to the voltage adjuster.

As described above, in the display device according to the exemplary embodiment of the present invention, the defect such as the washed-out color effects due to the driving at the high temperature and due to the increased driving time can be minimized.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a block diagram of a liquid crystal display (LCD) according to an exemplary embodiment of the present invention.

FIG. 2 is a block diagram of a gate voltage divider according to the exemplary embodiment of the present invention.

FIG. 3 is a graph for illustrating a temperature variation-reflecting function Voff(t) of the gate-off voltage in the gate voltage divider according to the exemplary embodiment of the present invention.

FIG. 4 is a graph for illustrating a driving time-reflecting function Voff(s) of the gate-off voltage in the gate voltage divider according to the exemplary embodiment of the present invention.

FIG. 5 is a graph for illustrating a driving time-reflecting function Voff(s) of the gate-off voltage in a gate voltage divider according to another exemplary embodiment of the present invention.

FIG. 6 is a graph for illustrating the reason why the gate-off voltage of the thin film transistor of the display device according to the exemplary embodiment of the present invention should be changed.

### DETAILED DESCRIPTION OF THE INVENTION

The present invention will be described more fully hereinafter with reference to the accompanying drawings, in which exemplary embodiments of the invention are shown.

As those skilled in the art would realize, the described embodiments may be modified in various different ways, all without departing from the spirit or scope of the present invention.

In the drawings, the thickness of layers, films, panels, regions, etc. are exaggerated for clarity.

Like reference numerals designate like elements throughout the specification.

It will be understood that when an element such as a layer, film, region, or substrate is referred to as being “on” another element, it can be directly on the other element or intervening elements may also be present.

In contrast, when an element is referred to as being “directly on” another element, there are no intervening elements present.

First, a liquid crystal display (LCD) according to an exemplary embodiment of the present invention will be described with reference to the attached drawings.

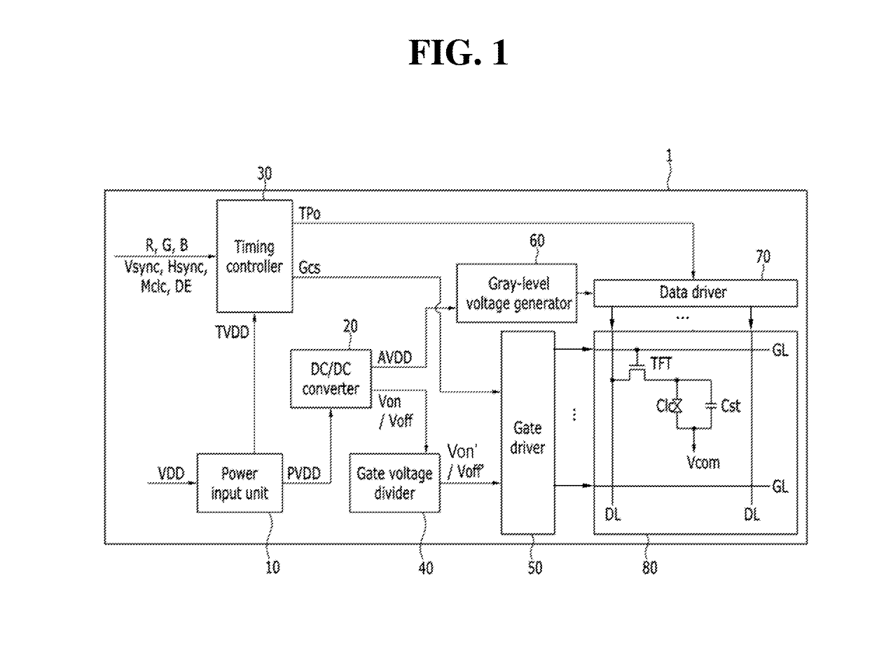

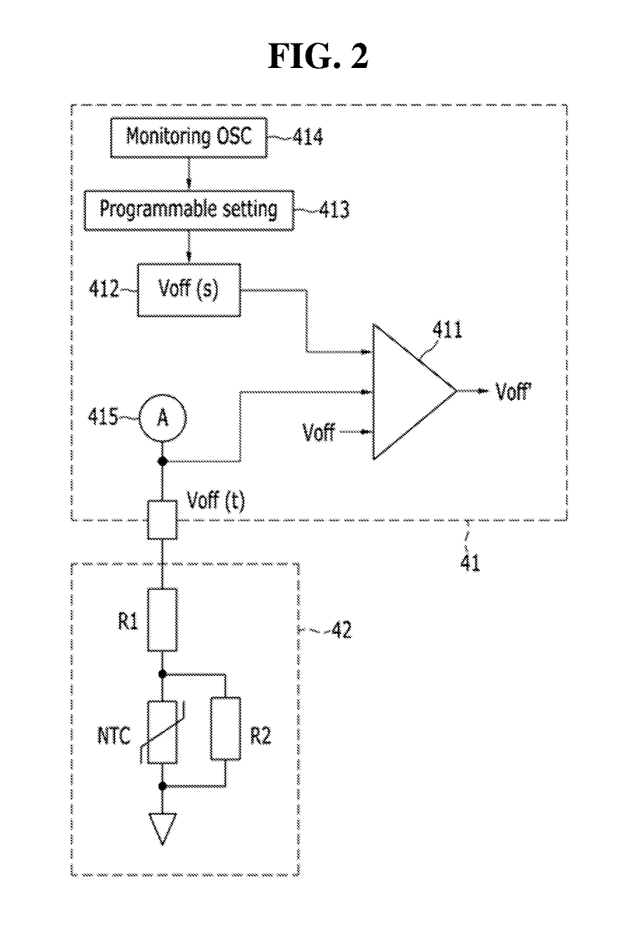

FIG. 1 is a block diagram of an LCD according to an exemplary embodiment of the present invention, and FIG. 2 is a block diagram of a gate voltage divider according to the exemplary embodiment of the present invention.

As shown in FIG. 1, the LCD according to the exemplary embodiment of the present invention includes: a liquid crystal panel assembly 80; a gate driver 50 and a data driver 70 connected thereto; a gray-level voltage generator 60 connected to the data driver 70; a gate voltage divider 40 connected to the gate driver 50; a power input unit 10 for receiving power from the outside; a DC/DC converter 20 connected between the power input unit 10 and the gate voltage divider 40 and between the power input unit 10 and the gray-level voltage generator 60; and a timing controller 30 for controlling them.

When viewed as an equivalent circuit, the liquid crystal panel assembly 80 includes a plurality of signal lines GL and DL, and a plurality of pixels that are connected thereto and arranged in an approximate matrix form.

Each pixel includes a thin film transistor (TFT), a liquid crystal capacitor Clc, and a storage capacitor Cst.

The liquid crystal capacitor Clc is formed between a pixel electrode (not shown) and a common electrode voltage Vcom while using a liquid crystal layer as a dielectric material therebetween, and the storage capacitor Cst is formed between the pixel electrode and the common electrode voltage Vcom while using an insulating layer, such as a gate insulating layer and the like, as a dielectric material therebetween.

The gray-level voltage generator 60 generates all gray-level voltages related to transmittance of a pixel or a limited number of gray-level voltages (hereinafter referred to as “reference gray-level voltages”).

The (reference) gray-level voltages may include voltages that are positive and negative with respect to the common voltage Vcom.

The gate driver 50 applies a gate signal consisting of gate-on and gate-off voltages Von and Voff to the gate lines GL while being connected to the gate lines GL of the liquid crystal panel assembly 80.

The data driver 70 is connected to the data lines DL of the liquid crystal panel assembly 80, and selects the gray-level voltages from the gray-level voltage generator 60 to apply them as a data signal to the data lines DL.

However, when the gray-level voltage generator 60 does not provide the voltages for all gray levels but only the predetermined number of reference gray-level voltages, the data driver 70 generates the gray-level voltages for all gray levels by dividing the reference gray-level voltages so as to select the data signal among them.

The timing controller 30 receives an image signal generated from the outside, allowing the gate driver 50 and the data driver 70 to display based on it.

The DC/DC converter 20 provides a reference gate-on voltage Von and a reference gate-off voltage Voff to the gate voltage divider 40, and provides an analog driving voltage AVDD to the gray-level voltage generator 60.

The power input unit 10 receives a driving voltage VDD from a power output unit of the system to output a timing driving voltage TVDD to the timing controller 30, and outputs a power driving voltage PVDD to the DC/DC converter 20.

The gate voltage divider 40 adjusts the reference gate-off voltage Voff provided by the DC/DC converter 20 as temperature changes and the driving time elapses, and then generates an adjusted gate-off voltage Voff′ to provide it, along with the reference gate-on voltage Von, to the gate driver 50.

Referring to FIG. 2, the gate voltage divider 40 according to the exemplary embodiment of the present invention includes a power management integrated circuit (PMIC) 41 and a temperature-reflecting unit 42.

The temperature-reflecting unit 42 includes a negative temperature coefficient (NTC) resistor with resistance that increases as temperature increases and two resistors R1 and R2, and the NTC resistor is connected to the resistor R2 in parallel and to the resistor R1 in series.

The power controller 41 includes: a voltage adjuster 411 for outputting the adjusted gate-off voltage Voff by receiving and then appropriately adjusting the reference gate-off voltage Voff; a monitoring OSC 414 for monitoring the driving time of the display device to output a result; a programmable setting 413 for outputting an adjusted voltage in response to the driving time outputted by the monitoring oscillator 414; a driving time-reflecting voltage provider 412 for generating an analog voltage Voff(s) corresponding to the voltage outputted by the programmable setting 413 to output it to the voltage adjuster 411; and a constant current source 415 for supplying a constant current to the temperature-reflecting unit 42.

A branch point is created between the constant current source 415 and the temperature-reflecting unit 42 such that a voltage Voff(t) applied to the temperature-reflecting unit 42 is input to the voltage adjuster 411.

In this case, the monitoring OSC 414, the programmable setting 413, and the driving time-reflecting voltage provider 412 may be referred to as a driving time-reflecting unit.

The voltage adjuster 411 receives the voltage Voff(s) provided by the driving time-reflecting voltage provider 412 and the voltage Voff(t) applied to the temperature-reflecting unit 42, and then subtracts them from the reference gate-off voltage Voff to output the result as the adjusted gate-off voltage Voff.

When a temperature of the display device increases, the resistance of the NTC resistor increases, and the voltage applied to the temperature-reflecting unit 42 (branch point voltage) accordingly increases.

Accordingly, the adjusted gate-off voltage Voff further decreases.

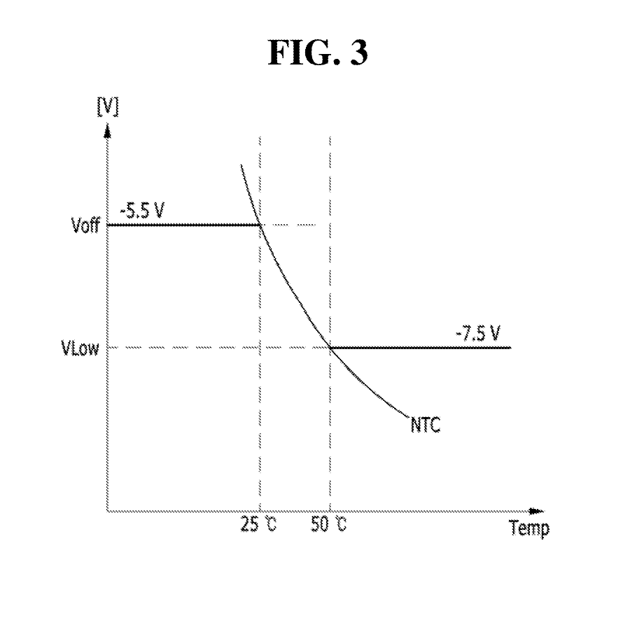

This can be understood with reference to FIG. 3.

FIG. 3 is a graph for illustrating a temperature variation-reflecting function Voff(t) of the gate-off voltage in the gate voltage divider according to the exemplary embodiment of the present invention.

At 25° C., the reference gate-off voltage Voff of −5.5 V is applied unchanged as the adjusted gate-off voltage Voff but is gradually adjusted to lower voltages along an NTC line as the temperature increases, and when the temperature reaches 50° C., −7.5 V that is 2 V lower than the reference gate-off voltage Voff is applied as the adjusted gate-off voltage Voff.

In addition, as the driving time of the display device increases, the voltage outputted by the programmable setting 413 further increases.

Accordingly, the adjusted gate-off voltage Voff further decreases.

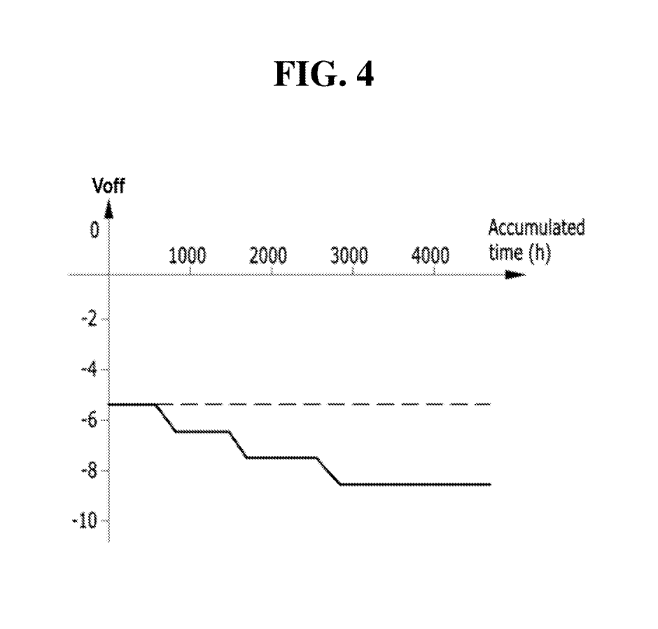

This can be understood with reference to FIG. 4.

FIG. 4 is a graph for illustrating a driving time-reflecting function Voff(s) of the gate-off voltage in the gate voltage divider according to the exemplary embodiment of the present invention.

Before reaching 700 hours of operation of the display device, the reference gate-off voltage Voff of −5.5 V is applied unchanged as the adjusted gate-off voltage Voff, but after reaching 700 hours, it is gradually adjusted to the low voltages and −6.5 V is applied as the adjusted gate-off voltage Voff′ when reaching 1000 hours.

The adjusted gate-off voltage Voff is maintained at −6.5 V until reaching 1500 hours and then gradually decreases, and decreases to −7.5 V after reaching 1800 hours.

As such, when the voltage outputted by the programmable setting 413 is set to gradually increase with elapse of the driving time in accordance with a level of performance deterioration of the thin film transistor, the defect such as the washed-out color effect that can occur due to the performance deterioration of the thin film transistor with the elapse of the driving time can be prevented.

FIG. 4 is exemplarily illustrated, so the driving time and the adjusted gate-off voltage that accordingly decreases with the elapse of the driving time may be different depending on specifications of each display device.

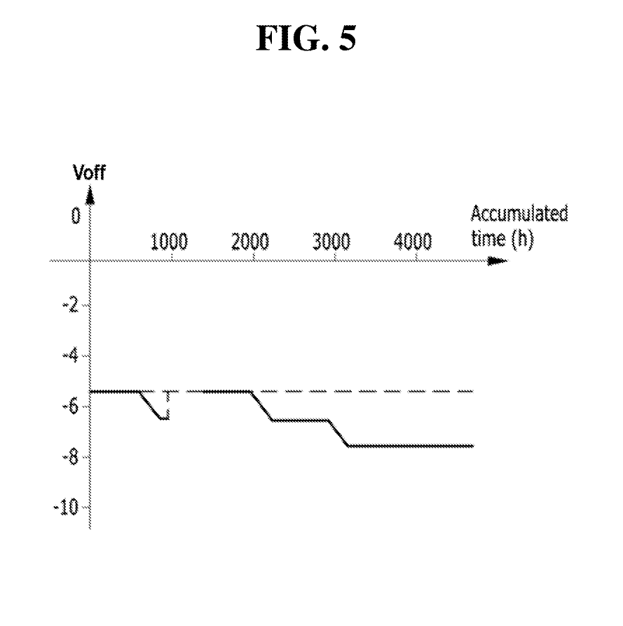

FIG. 5 is a graph for illustrating a driving time-reflecting function Voff(s) of the gate-off voltage in a gate voltage divider according to another exemplary embodiment of the present invention.

The above exemplary embodiment in which the adjusted gate-off voltage simply decreases with the elapse of the driving time has been described.

However, if a predetermined time elapses since the operation of the thin film transistor is stopped, the original performance may be restored.

Accordingly, in order to reflect this, in the current exemplary embodiment, if the predetermined time is elapsed since the operation is stopped, the adjusted gate-off voltage Voff′ should be restored to the reference gate-off voltage Voff.

That is, referring to FIG. 2, the monitoring OSC 414 monitors an operation stoppage time as well as the driving time, and the programmable setting 413 outputs the adjusted voltage, which reflects performance deterioration of the thin film transistor with the elapse of the driving time and performance restoration of the thin film transistor after the operation stoppage time, to the driving time-reflecting voltage provider 412.

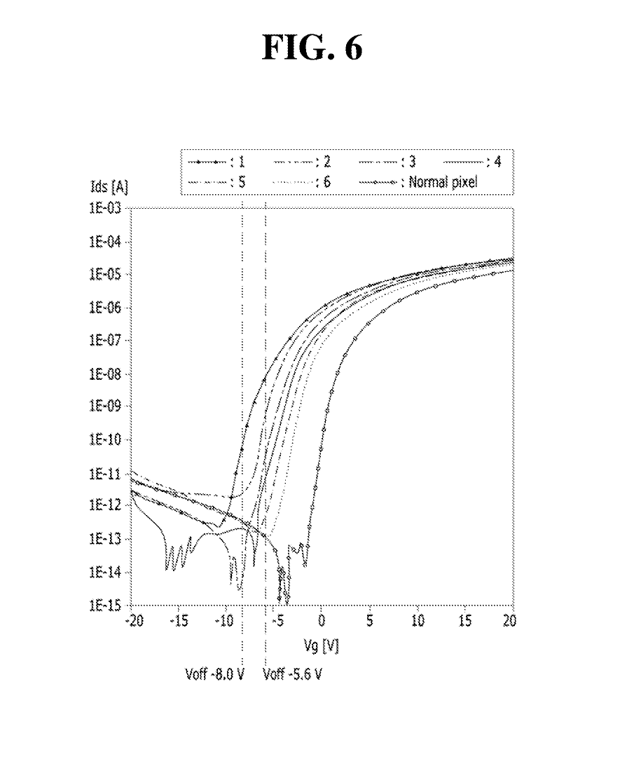

FIG. 6 is a graph for illustrating the reason why the gate-off voltage of the thin film transistor of the display device according to the exemplary embodiment of the present invention should be changed.

Referring to FIG. 6, at an initial driving stage of the display device, a current characteristic according to the gate voltage of the thin film transistor follows curves including circles.

Accordingly, even if the gate-off voltage of −5.6 V is applied, a leakage current is extremely small at 1/10¹³ A.

However, when the current characteristic according to the gate voltage of the thin film transistor follows curves including triangles as the driving time and the temperature increase, and the gate-off voltage of −5.6 V is applied, the leakage current of as much as 1/10⁸ A flows, thereby resulting in the leakage current exceeding 1 nA.

However, if the driving time and the temperature are reflected to adjust the gate-off voltage to −8.0 V, the leakage current can be controlled within 1/10¹⁰ A.

In the above description, the LCD is described as the exemplary embodiment of the present invention, but the present invention can also be applied to various kinds of display devices such as the OLED display and the like.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

10: power input unit
20: DC/DC converter
30: timing controller
40: gate voltage divider
50: gate driver
60: gray-level voltage generator
70: data driver
80: liquid crystal panel assembly
41: power controller
42: temperature-reflecting unit
411: voltage adjuster
412: driving time-reflecting voltage provider
413: programmable setting
414: monitoring oscillator
415: constant current source

What is claimed is:

1. A display device comprising:
a display panel including a plurality of gate lines, a plurality of data lines, and a plurality of pixels;
a gate driver connected to the plurality of gate lines to apply a gate signal voltage;
a data driver connected to the plurality of data lines to apply a data voltage and a negative data voltage;
and a gate voltage divider generating the gate signal voltage including a gate-on voltage and a gate-off voltage to provided it to the gate driver,
wherein the gate voltage divider adjusts the gate-off voltage in accordance with a driving time of the display panel and a temperature of the display panel.

2. The display device of claim 1, wherein the gate voltage divider includes:
a driving time-reflecting unit providing a voltage to be adjusted according to the driving time of the display panel;
a temperature-reflecting unit providing a voltage to be adjusted according to the temperature of the display panel;
and a voltage adjuster outputting a voltage calculated by subtracting the voltages provided by the driving time-reflecting unit and the temperature-reflecting unit from a reference gate-off voltage.

3. The display device of claim 2, wherein the driving time-reflecting unit includes:
a monitoring oscillator (OSC) monitoring the driving time of the display panel;
a programmable setting outputting a preset voltage in response to the driving time provided by the monitoring OSC;
and a driving time-reflecting voltage provider providing an analog voltage corresponding to the voltage provided by the programmable setting to the voltage adjuster.

4. The display device of claim 2, wherein the temperature-reflecting unit includes a first resistor and a second resistor, and a variable resistor that is connected to the first resistor in series and to the second resistor in parallel.

5. The display device of claim 4, wherein the variable resistor is a negative temperature coefficient (NTC) resistor.

6. The display device of claim 2, wherein the driving time-reflecting unit determines the voltage to be adjusted by reflecting both performance deterioration of the thin film transistor according to elapse of the driving time of the display panel and performance restoration of the thin film transistor according to elapse of an operation stoppage time of the display panel.

7. The display device of claim 6, wherein the driving time-reflecting unit includes:
a monitoring OSC monitoring the driving time of the display panel and an operation stoppage time;
a programmable setting outputting a preset voltage in response to the driving time and the operation stoppage time provided by the monitoring OSC;
and a driving time-reflecting voltage provider providing an analog voltage corresponding to the voltage provided by the programmable setting to the voltage adjuster.

8. A gate driving device comprising:
a gate driver outputting a gate signal voltage including gate-on and gate-off voltages driving thin film transistors formed in a display panel;
and a gate voltage divider generating the gate signal voltage to provide it to the gate driver,
wherein the gate voltage divider adjusts the gate-off voltage in accordance with a driving time of the display panel and a temperature of the display panel.

9. The gate driving device of claim 8, wherein the gate voltage divider includes:
a driving time-reflecting unit providing a voltage to be adjusted according to the driving time of the display panel;
a temperature-reflecting unit providing a voltage to be adjusted according to the temperature of the display panel;
and a voltage adjuster outputting a voltage calculated by subtracting the voltages provided by the driving time-reflecting unit and the temperature-reflecting unit from a reference gate-off voltage.

10. The gate driving device of claim 9, wherein the driving time-reflecting unit includes:
a monitoring OSC monitoring the driving time of the display panel;
a programmable setting outputting a preset voltage in response to the driving time provided by the monitoring OSC;
and a driving time-reflecting voltage provider providing an analog voltage corresponding to the voltage provided by the programmable setting to the voltage adjuster.

11. The gate driving device of claim 9, wherein the temperature-reflecting unit includes a first resistor and a second resistor, and a variable resistor that is connected to the first resistor in series and to the second resistor in parallel.

12. The gate driving device of claim 11, wherein the variable resistor is an NTC resistor.

13. The gate driving device of claim 9, wherein the driving time-reflecting unit determines the voltage to be adjusted by reflecting both performance deterioration of the thin film transistor according to elapse of the driving time of the display panel and performance restoration of the thin film transistor according to elapse of an operation stoppage time of the display panel.

14. The gate driving device of claim 13, wherein the driving time-reflecting unit includes:
a monitoring OSC monitoring the driving time of the display panel and the operation stoppage time;
a programmable setting outputting a preset voltage in response to the driving time and the operation stoppage time provided by the monitoring OSC;
and a driving time-reflecting voltage provider providing an analog voltage corresponding to the voltage provided by the programmable setting to the voltage adjuster.
